(19) United States
(12) Patent Application Publication
(10) Pub. No.: US 2025/0004547 A1
(43) Pub. Date: Jan. 2, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: WATARU SUZAKI, Tokyo (JP); KAZUFUMI ONUMA, Kanagawa (JP)

(21) Appl. No.: 18/756,579

(22) Filed: Jun. 27, 2024

(30) Foreign Application Priority Data
Jun. 28, 2023 (JP) 2023-105952

(51) Int. Cl. G06F 3/01; G06T 15/20

(52) U.S. Cl. CPC G06F 3/013; G06T 15/20

(57) ABSTRACT

An image generation apparatus performs control in a manner that three or more virtual viewpoint images which include a same subject are acquired, and a particular virtual viewpoint image among the three or more virtual viewpoint images displayed in first display regions is displayed in a second display region which is larger than the first display regions based on a user operation.

### BACKGROUND OF THE DISCLOSURE

### Field of the Disclosure

The present disclosure relates to a technique for controlling display of a virtual viewpoint image.

### Description of the Related Art

A technique with which a plurality of cameras are installed in different positions to perform image capturing in a synchronous manner, and by using a plurality of images acquired by the image capturing, an image (virtual viewpoint image) is generated from any virtual camera (virtual viewpoint) based on a user operation has attracted attention. According to such a technique, for example, highlight scenes of soccer or basketball can be viewed from various angles, and as compared with an ordinary image, it is possible to provide a higher sense of realism to a user.

Japanese Patent Laid-Open No. 2019-114869 discloses a technique with which viewpoint information such as a position and an orientation of a virtual camera is registered, and by reading out the registered viewpoint information based on a user operation, switching to the virtual camera in the registered position and orientation is performed at any timing.

### SUMMARY OF THE DISCLOSURE

An image processing apparatus according to an aspect of the present disclosure includes an acquisition unit configured to acquire three or more virtual viewpoint images which include a same subject, and a display control unit configured to perform control in a manner that a particular virtual viewpoint image among the three or more virtual viewpoint images displayed in first display regions is displayed in a second display region which is larger than the first display regions based on a user operation.

Further features of the present disclosure will become apparent from the following description of exemplary embodiments with reference to the attached drawings.

### BRIEF DESCRIPTION OF THE DRAWINGS

FIG. 1 illustrates an example of a configuration of an image generation apparatus.

FIG. 2 illustrates an installation example of an image capturing system.

FIG. 3 is an explanatory diagram for describing tracking information.

FIG. 4 is an explanatory diagram for describing a pursuit viewpoint.

FIG. 5A and FIG. 5B are explanatory diagrams for describing a display unit and an input apparatus.

FIG. 6 illustrates an example of a world coordinate system.

FIG. 7 illustrates an example of a hardware configuration of the image generation apparatus.

FIG. 8 illustrates a functional configuration of a virtual viewpoint generation unit.

FIG. 9 illustrates a functional configuration of a display control unit.

FIG. 10 is an explanatory diagram for describing display content displayed on the display unit.

FIG. 11 is a flowchart illustrating processing for the image generation apparatus to display a virtual viewpoint image for operation and virtual viewpoint images for switching on the display unit.

FIG. 12 is an explanatory diagram for describing a display order for the display control unit to display the virtual viewpoint images for switching.

FIG. 13 is a flowchart representing a flow of processing for the display control unit to switch the selected virtual viewpoint image for switching and the virtual viewpoint image for operation.

FIG. 14A and FIG. 14B illustrate display screens to be displayed in the processing for the display unit to switch the selected virtual viewpoint image for switching and the virtual viewpoint image for operation.

### DESCRIPTION OF THE EMBODIMENTS

Hereinafter, with reference to the accompanying drawings, the disclosure of the present application will be described in detail by way of embodiments. It is noted that configurations illustrated in the following embodiments are merely examples, and the present disclosure is not limited to the illustrated configurations.

An image processing system is a system configured to generate, based on a plurality of images based on image capturing by a plurality of image capturing apparatuses and a designated virtual viewpoint, a virtual viewpoint image representing a scene from the designated virtual viewpoint. The virtual viewpoint image according to the present embodiment is also referred to as a volumetric video image, but is not limited to an image corresponding to a viewpoint freely (optionally) designated by a user. For example, an image corresponding to a viewpoint selected by the user from among a plurality of candidates or the like is also included in the virtual viewpoint image. In addition, according to the present embodiment, a case will be mainly described where the virtual viewpoint image is a moving image, but the virtual viewpoint image may be a still image.

Viewpoint information used to generate the virtual viewpoint image is information indicating a position and an orientation (line-of-sight direction) of the virtual viewpoint. Specifically, the viewpoint information is a parameter set including a parameter representing a three-dimensional position of the virtual viewpoint, and a parameter representing an orientation of the virtual viewpoint in pan, tilt, and roll directions. It is noted that content of the viewpoint information is not limited to the above. For example, the parameter set serving as the viewpoint information may include a parameter representing a size (viewing angle) of a visual field of the virtual viewpoint. In addition, the viewpoint information may have a plurality of parameter sets. For example, the viewpoint information may be information having a plurality of parameter sets respectively corresponding to a plurality of frames constituting the moving image of the virtual viewpoint image and indicating a position and an orientation of the virtual viewpoint at each of a plurality of successive points in time.

It is noted that each of the plurality of image capturing apparatuses according to the present embodiment is assumed to be a camera which has an individual casing and can perform image capturing from a single viewpoint. It is noted however that the configuration is not limited to this, and two or more image capturing apparatuses may be constituted in an identical casing. For example, a stand-alone camera which includes a plurality of lens groups and a plurality of sensors and can perform image capturing from a plurality of viewpoints may be installed as the plurality of image capturing apparatuses.

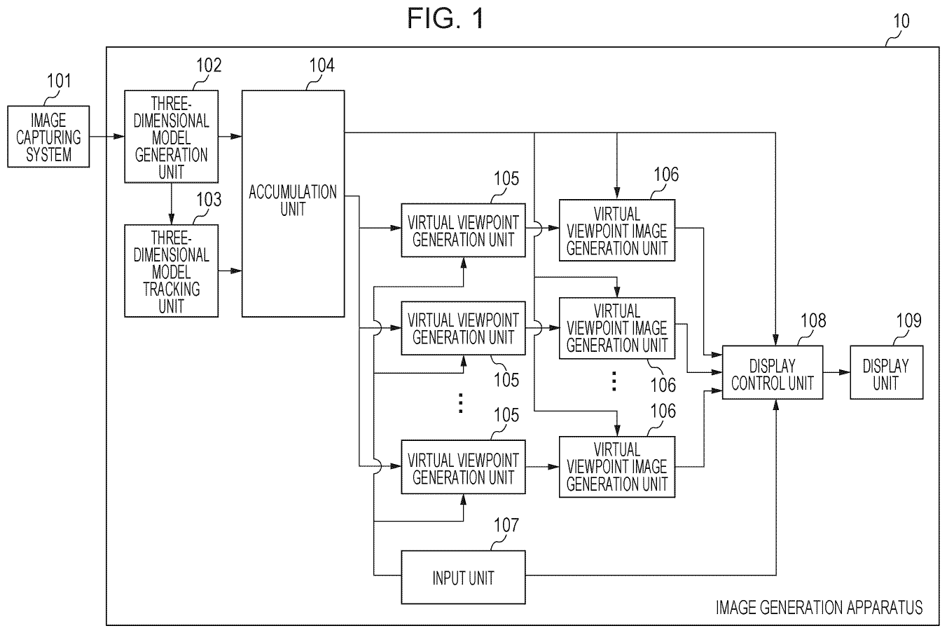

FIG. 1 is a configuration diagram of an image generation apparatus 10. The image generation apparatus 10 includes a three-dimensional model generation unit 102, a three-dimensional model tracking unit 103, an accumulation unit 104, a virtual viewpoint generation unit 105, a virtual viewpoint image generation unit 106, an input unit 107, a display control unit 108, and a display unit 109. It is noted that the configuration is not limited to the above, and a plurality of units may be included in another apparatus. For example, the three-dimensional model tracking unit 103, the virtual viewpoint generation unit 105, the input unit 107, the display control unit 108, and the display unit 109 may be included in another image processing apparatus.

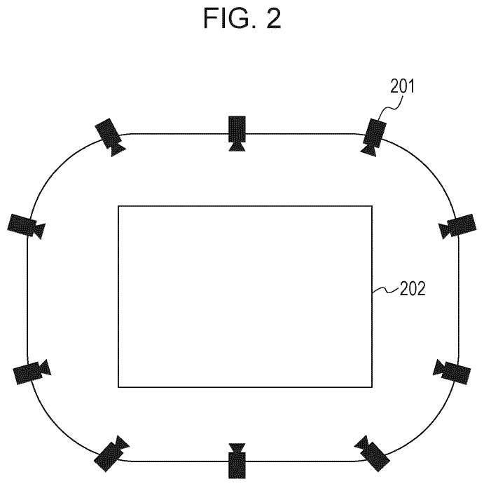

As illustrated in FIG. 2, in an image capturing system 101, a plurality of physical cameras 201 are respectively installed in different positions so as to surround an image capturing region 202 and perform image capturing in a time synchronization manner. A plurality of images captured in a time synchronization manner from multiple viewpoints are transmitted to the three-dimensional model generation unit 102. The image capturing region 202 is an image capturing studio where image capturing for generating a virtual viewpoint image is performed, a stadium where a sport competition is held, a stage where a concert or a play is performed, or the like. The image capturing system 101 may be an apparatus configured to capture not only a video image but also audio or other sensor information.

The three-dimensional model generation unit 102 extracts a subject as a foreground from a plurality of captured images transmitted from the image capturing system 101 and generates a three-dimensional model of the subject from foreground images which have been extracted.

As a method of extracting the foreground, a method of using background subtraction information has been proposed. For example, an image of a state in which the foreground is not present is captured in advance as a background image, and a difference between an image in which the foreground is present and the background image is calculated. When a difference value is higher than a threshold, it is determined that a corresponding pixel position is the foreground. In addition, with regard to a technique of extracting the foreground, various techniques have been proposed such as a technique of using a characteristic amount on an image related to the subject or machine learning. In the present proposal, any technique of extracting the foreground may be used. The three-dimensional model may be generated by a visual volume intersection method, or may be generated by using depth data acquired from stereoscopic image processing. In the present application, a method of generating the three-dimensional model is not limited. The generated three-dimensional model is transmitted to the three-dimensional model tracking unit 103 and the accumulation unit 104.

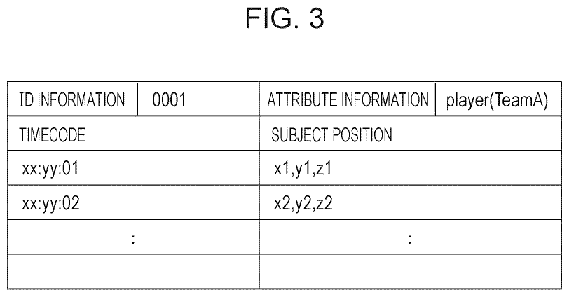

The three-dimensional model tracking unit 103 appends an identifier to each three-dimensional model generated by the three-dimensional model generation unit 102 and also appends position information of the three-dimensional model as tracking information to be transmitted to the accumulation unit 104. The identifier has specific ID information for identifying each subject, and attribute information for identifying an attribute of the subject such as a team to which each subject belongs. As illustrated in FIG. 3, the tracking information has position information of the three-dimensional model at each point in time (timecode) and is stored in association with the identifier. A position of the subject is approximated, for example, by a center of gravity of a bounding box which surrounds the subject. It is noted that the position information may associate a radio frequency identification (RFID) tag (for example, GPS) attached to the subject with the three-dimensional model. According to the present embodiment, a tracking method of the three-dimensional model includes using the RFID tag, but is not limited to this. For example, a representative position of the subject may be decided by using a part of the three-dimensional model of the subject, and the tracking information may be generated from a movement range of the representative position of the subject in consecutive frames.

The accumulation unit 104 saves and accumulates a group of data (material data) used to generate the virtual viewpoint image, and the tracking information. Specifically, the material data includes the captured images and the three-dimensional model which are received from the three-dimensional model generation unit 102, and a camera parameter of each of the image capturing apparatuses. It is noted that a background model and a background texture image are saved in advance in the accumulation unit 104 as data used to generate a background of the virtual viewpoint image. The background model may be data such as a studio set or a field of a stadium captured in advance, or may be data in an imaginary space generated by computer graphics (CG). According to the present embodiment, it is assumed that a three-dimensional model of a goal of basketball which serves as the background model is saved. The material data group and the tracking information which are accumulated in the accumulation unit 104 are transmitted to the virtual viewpoint generation unit 105, the virtual viewpoint image generation unit 106, and the display control unit 108 according to the processing of the image generation apparatus 10.

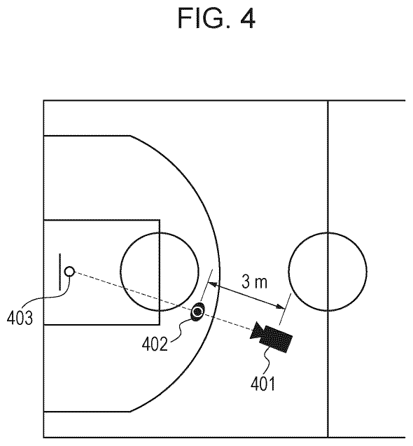

The virtual viewpoint generation unit 105 generates, based on the tracking information received from the accumulation unit 104, a camera parameter of a virtual camera which serves as a viewpoint (pursuit viewpoint) for pursing the three-dimensional model. The camera parameter of the virtual camera includes parameters for designating a position and an orientation, a focal distance, a viewing angle, and a point in time. It is noted that the camera parameter may include a parameter which defines another element, or a configuration may be adopted where a part of the above-described parameters is not included in the camera parameter. The generated camera parameter is transmitted to the virtual viewpoint image generation unit 106. For example, as illustrated in FIG. 4, the camera parameter is controlled such that a virtual camera 401 is located in a position 3 meters away from a player 402 who is set as a pursuit target which is also a position on a single straight line linking the player 402 set as the pursuit target and a goal 403.

It is noted that the position of the camera parameter of the pursuit viewpoint is not limited to this. For example, the position may be set in a position away from the position on single straight line linking the player 402 set as the pursuit target and the goal 403 by a predetermined distance. It suffices when the pursuit target and an object-of-interest are included in a viewing angle of the virtual camera. In addition, a method of deciding the camera parameter of the pursuit viewpoint is not limited to this. According to the present embodiment, the image generation apparatus 10 includes the plurality of virtual viewpoint generation units 105 to generate camera parameters of virtual cameras which pursuit three-dimensional models of mutually different subjects. The camera parameters of the virtual cameras generated by the plurality of virtual viewpoint generation units 105 are transmitted to the mutually different virtual viewpoint image generation units 106. It is noted that the configuration is not limited to this, and the single virtual viewpoint generation unit 105 may generate camera parameters of a plurality of virtual cameras, and the camera parameters of the plurality of virtual cameras may be transmitted to the single virtual viewpoint image generation unit 106.

The virtual viewpoint image generation unit 106 acquires the material data from the accumulation unit 104 and the camera parameter of the virtual camera from the virtual viewpoint generation unit 105 to generate the virtual viewpoint image corresponding to the virtual camera. For example, model base rendering can be used as a method of generating the virtual viewpoint image. Through this processing, the virtual viewpoint image viewed from the position and the orientation of the virtual camera can be generated. It is noted that the method of generating the virtual viewpoint image is not limited to this. It is noted that unless otherwise stated, descriptions will be provided while an expression “image” in the present disclosure includes concepts of both the moving image and the still image. The generated virtual viewpoint image is transmitted to the display control unit 108.

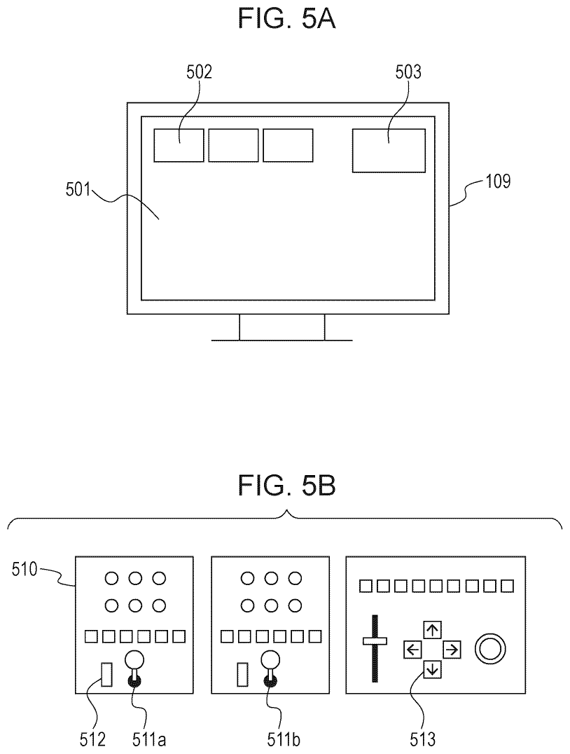

FIG. 5A and FIG. 5B are explanatory diagrams for describing the display unit 109 and an input apparatus 510. FIG. 5A illustrates a layout of a virtual viewpoint image for operation and virtual viewpoint images for switching which are displayed on the display unit 109, and FIG. 5B illustrates an example of the input apparatus 510 connected to the input unit 107.

As in the example of FIG. 5B, the input unit 107 acquires input information based on a user operation from the input apparatus 510. The input apparatus 510 includes a stick 511a, a stick 511b, a seesaw switch 512, and a button group 513. The user operates those components to change the camera parameter of the virtual camera. Each of the stick 511a and the stick 511b has an operation shaft with three degrees of freedom. The position of the virtual camera is operated by the stick 511a, and the orientation of the virtual camera is operated by the stick 511b. In addition, the seesaw switch 512 is turned to a plus side or a minus side to change a value of the focal distance or the viewing angle of the virtual camera. The button group 513 has arrow buttons indicating up, down, left and right directions with which the user switches the virtual viewpoint for operation and the virtual viewpoint for switching. It is noted that the configuration of the input apparatus 510 is not limited to this. For example, a tablet terminal, a keyboard, a mouse, or the like may be used as the input apparatus 510. The input information is information for changing the position and the orientation of the virtual camera or the value of the focal distance or the viewing angle, information for switching the virtual viewpoint for operation and the virtual viewpoint for switching, or the like.

The display control unit 108 sets virtual viewpoint images to be displayed in a display region 501 (second display region) of the virtual viewpoint for operation and display regions 502 (first display regions) of the virtual viewpoint for switching. As illustrated in FIG. 5A, the display region 501 of the virtual viewpoint for operation and the display regions 502 of the virtual viewpoint for switching are arranged on the display screen of the display unit 109. The virtual viewpoint image of the virtual viewpoint for operation which accepts a user operation for changing the position and the orientation of the virtual camera is displayed in the display region 501 of the virtual viewpoint for operation.

The virtual viewpoint images of the virtual viewpoints (virtual viewpoints for switching) which can be switched as the virtual viewpoint for operation are displayed in the display regions 502 of the virtual viewpoint for switching. An arrangement order of the virtual viewpoint images to be displayed as the virtual viewpoints for switching is decided based on the position information of the three-dimensional model of the pursuit target at each of the viewpoints. The display region 502 of the virtual viewpoint for switching includes a plurality of display regions 502, and in the example of FIG. 5A, the three display regions 502 are provided. It is noted that a plurality of virtual viewpoint images for switching may be displayed side by side in a single display region. When the user selects one of the virtual viewpoints for switching via the input unit 107, the selected virtual viewpoint for switching is set as the virtual viewpoint for operation to be displayed in the display region 501 of the virtual viewpoint for operation. In addition, the display control unit 108 sets an image to be displayed in a third display region 503.

According to the present embodiment, an overhead image is displayed in the third display region 503, but the configuration is not limited to this. For example, a virtual advertisement, a scoring state of a match, or the like may be displayed.

The display unit 109 displays the virtual viewpoint image for operation and the virtual viewpoint images for switching which are set by the display control unit 108.

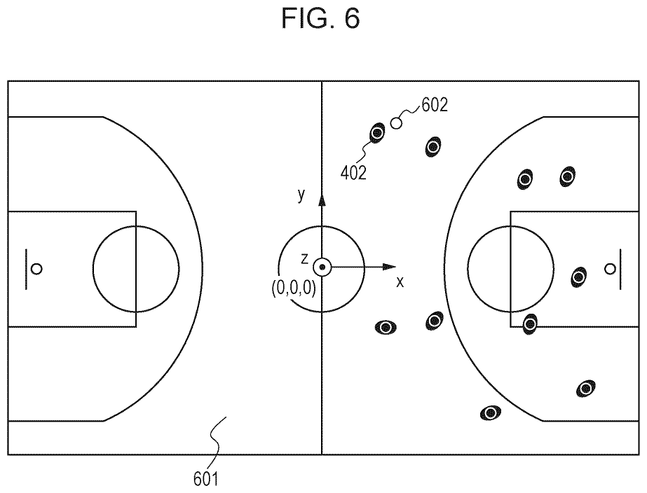

FIG. 6 illustrates a world coordinate system (x, y, z) in an image capturing space of the virtual camera. The world coordinate system is used to represent a position of the camera parameter of the virtual camera or the subject. Herein, the subject refers to a tangible entity which is present in the image capturing space, such as a field 601, a ball 602, or the player 402. In the world coordinate system, a center of the field 601 is set as a point of origin (0, 0, 0). In addition, an x-axis is set as a long side direction of the field 601, a y-axis is set as a short side direction of the field 601, and a z-axis is set as a vertical direction to the field 601. It is noted that a method of setting the world coordinate system is not limited to this.

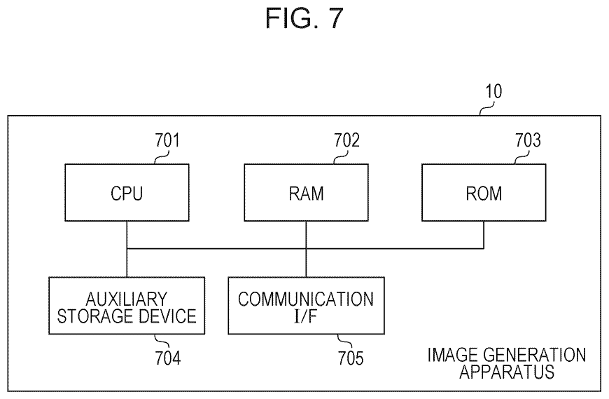

FIG. 7 illustrates an example of a hardware configuration of the image generation apparatus 10. The image generation apparatus 10 includes a central processing unit (CPU) 701, a random access memory (RAM) 702, a read only memory (ROM) 703, an auxiliary storage device 704, and a communication interface (I/F) 705.

The CPU 701 realizes each function of the image generation apparatus 10 illustrated in FIG. 1 by controlling an entirety of the image generation apparatus 10 by using a computer program or data stored in the RAM 702 or the ROM 703. It is noted that the image generation apparatus 10 may have one or a plurality of pieces of dedicated hardware different from the CPU 701, and at least part of processing by the CPU 701 may be executed by the dedicated hardware. Examples of the dedicated hardware include an application-specific integrated circuit (ASIC), a field programmable gate array (FPGA), a digital signal processor (DSP), and the like. The RAM 702 temporarily stores a program or data supplied from the auxiliary storage device 704, data supplied from the outside via the communication I/F 705, and the like. The ROM 703 stores a program which does not require changes, and the like. For example, the auxiliary storage device 704 is constituted by a hard disk drive or the like and stores various data such as image data and audio data. The communication I/F 705 is used for communication with an external apparatus of the image generation apparatus 10. For example, when the image generation apparatus 10 is connected to the external apparatus in a wired manner, a cable for communication is connected to the communication I/F 705. When the image generation apparatus 10 has a function of performing wireless communication with the external apparatus, the communication I/F 705 includes an antenna.

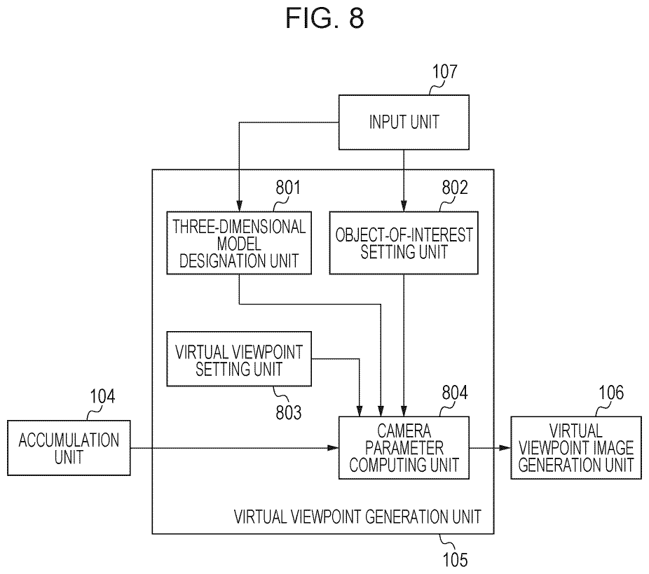

FIG. 8 is a block diagram representing a functional configuration example of the virtual viewpoint generation unit 105. The virtual viewpoint generation unit 105 includes a three-dimensional model designation unit 801, an object-of-interest setting unit 802, a virtual viewpoint setting unit 803, and a camera parameter computing unit 804.

The three-dimensional model designation unit 801 designates a three-dimensional model which generates the pursuit viewpoint among the three-dimensional models tracked by the three-dimensional model tracking unit 103. For the designation of the three-dimensional model which generates the pursuit viewpoint, the user designates the three-dimensional model via the input unit 107. Alternatively, the three-dimensional model may be designated from attribute information included in the tracking information. For example, a three-dimensional model having “player (TeamA)” as the attribute information is designated as the three-dimensional model which generates the pursuit viewpoint. The three-dimensional model designation unit 801 is included in each of the virtual viewpoint generation units 105. The three-dimensional model designation unit 801 designates mutually different three-dimensional models.

The object-of-interest setting unit 802 sets an object-of-interest for deciding the camera parameter of the pursuit viewpoint. The object-of-interest is a three-dimensional model serving as a reference of the position and the orientation of the virtual camera and is set by the user via the input unit 107. The user does not necessarily need to set the object-of-interest. When the user does not set the object-of-interest, the three-dimensional model of the subject set for each competition becomes the object-of-interest by default. For example, in the case of basketball, a goal is set as the object-of-interest by default. It is noted that the object-of-interest is assumed to be a stationary object, but is not limited to this. For example, in a racing such as a horse racing or a bicycle racing, a lead racer may be set as the object-of-interest. In the above-described case, regarding the pursuit viewpoint which will be described below, it is possible to generate such a pursuit viewpoint as to face the lead racer from a racer-of-interest to pursue the lead racer. Each of the pursuit viewpoints serves as a viewpoint at which the subject of the pursuit target and the object-of-interest are included in the viewing angle of the virtual camera. The object-of-interest is a three-dimensional model which is common at each of the pursuit viewpoints, and is set as a three-dimensional model other than the subject of the pursuit target at each of the pursuit viewpoints. That is, the virtual viewpoints generated by the plurality of virtual viewpoint generation units 105 include the same subject in the viewing angle and also include mutually different subjects.

The virtual viewpoint setting unit 803 defines a condition for setting the position and the orientation of the virtual camera at the pursuit viewpoint. As the condition of the position and the orientation of the virtual camera, a distance between the subject of the pursuit target and the virtual camera, and a relationship among the subject of the pursuit target, the object-of-interest, and the position and the orientation of the virtual camera are set. For example, a virtual camera position is defined such that the virtual camera is located in a position away from a position of the subject of the pursuit target by 5 m at a height z=2.0 m, and also the virtual camera is located on a straight line linking the virtual camera, the subject of the pursuit target, and the object-of-interest in a stated order. The orientation of the virtual camera is defined such that a center of the subject of the pursuit target is regularly set to be on an optical axis of the virtual camera. It is noted that the condition of the position and the orientation of the virtual camera at the pursuit viewpoint is not limited to this. Any condition may be set as long as the subject of the pursuit target and the object-of-interest are present in the viewing angle of the virtual camera. Alternatively, any condition may be set as long as the distance between the subject of the pursuit target and the virtual camera becomes a value smaller than a distance between the object-of-interest and the virtual camera. For example, the virtual camera position may be on a straight line obtained by rotating the straight line linking the virtual camera, the subject of the pursuit target, and the object-of-interest in the stated order by a predetermined angle about the z-axis while the subject of the pursuit target is set as a center. The orientation of the virtual camera may be set such that the center of the subject of the pursuit target and a center of the object-of-interest are set to be on the optical axis.

The camera parameter computing unit 804 acquires the position information of the subject of the pursuit target and the three-dimensional models of the object-of-interest and computes a camera parameter of the virtual camera at the pursuit viewpoint based on the condition specified by the virtual viewpoint setting unit 803.

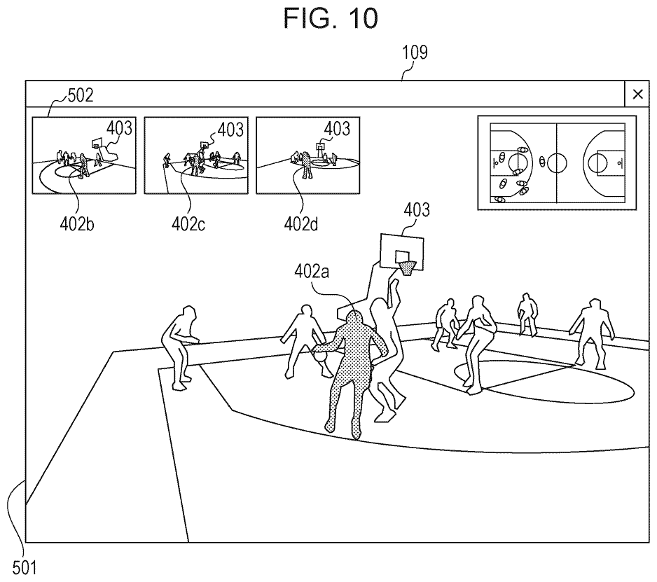

FIG. 10 is an explanatory diagram for describing display content displayed on the display unit 109. In the example of FIG. 10, the object-of-interest is the goal 403, and each of viewpoints for pursuing the player 402 set as the pursuit target is displayed in the display region 501 of the virtual viewpoint for operation and the display region 502 of the virtual viewpoint for switching. Herein, a suffix “a” represents the virtual viewpoint image displayed in the display region 501 of the virtual viewpoint for operation, and suffixes “b”, “c”, and “d” represent the individual virtual viewpoint images which are displayed in the display regions 502 of the virtual viewpoint for switching, respectively. On the other hand, both the virtual viewpoint image displayed in the display region 501 of the virtual viewpoint for operation and the virtual viewpoint images displayed in the display regions 502 of the virtual viewpoint for switching include the goal 403 that is the same object-of-interest.

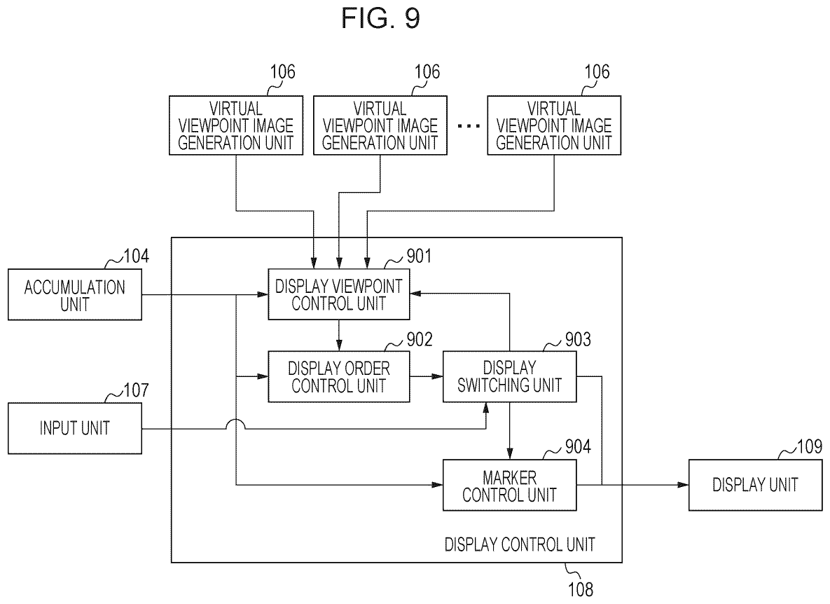

FIG. 9 is a block diagram representing a functional configuration example of the display control unit 108.

A display viewpoint control unit 901 acquires, from the virtual viewpoint image generation unit 106, information as to which subject is set as the pursuit target and position information of the three-dimensional model of the subject set as the pursuit target. Then, the pursuit viewpoint to be displayed in the display region 502 of the virtual viewpoint for switching is decided based on a relationship between the three-dimensional model of the pursuit target at the virtual viewpoint set as the virtual viewpoint for operation and the subject of the pursuit target set at another virtual viewpoint. The display viewpoint control unit 901 sets the virtual viewpoint determined to be displayed as the virtual viewpoint for switching. A detail of a method of deciding the virtual viewpoint to be displayed will be described below.

A display order control unit 902 decides an arrangement order for displaying, in the display regions 502 of the virtual viewpoint for switching, the virtual viewpoint images of the virtual viewpoints set as the virtual viewpoints for switching by the display viewpoint control unit 901 based on the position information of the three-dimensional models of the respective pursuit targets. A detail of a method of deciding the arrangement order will be described below. Information of the arrangement order of the pursuit viewpoints is transmitted to a display switching unit 903.

The display switching unit 903 arranges the virtual viewpoint images to be displayed in the display regions 502 of the virtual viewpoint for switching in accordance with the arrangement order decided by the display order control unit 902. When a user operation of switching the virtual viewpoint image for switching to the virtual viewpoint image for operation is acquired, the display switching unit 903 sets, as the virtual viewpoint for operation, the virtual viewpoint for switching selected by the user. In addition, the display switching unit 903 sets a layout of the screen such as a size or a display position of an image to be displayed on the display unit 109. A screen configuration of the display region 501 of the virtual viewpoint for operation and the display regions 502 of the virtual viewpoint for switching which are configured in the display unit 109 is decided based on the set layout. It is noted that according to the present embodiment, the display region 501 of the virtual viewpoint for operation is set to be larger than the display regions 502 of the virtual viewpoint for switching. In addition, when another image such as, for example, an overhead image depicting an entire field is displayed on the display unit, the display switching unit 903 sets a layout for the other display image too. When the overhead image is to be displayed, one of the virtual viewpoint image generation units 106 generates a virtual viewpoint image of the overhead image.

When a user operation of selecting the virtual viewpoint image for switching which is displayed in the display region 502 of the virtual viewpoint for switching is acquired, a marker control unit 904 highlights a subject corresponding to the selected virtual viewpoint image for switching. Specifically, a selection marker is superimposed on the position of the three-dimensional model of the subject set as the pursuit target in the selected virtual viewpoint image on the virtual viewpoint image displayed in the display region 501 of the virtual viewpoint for operation. With regard to the selection marker, a marker position moves as a player moves based on the tracked position information.

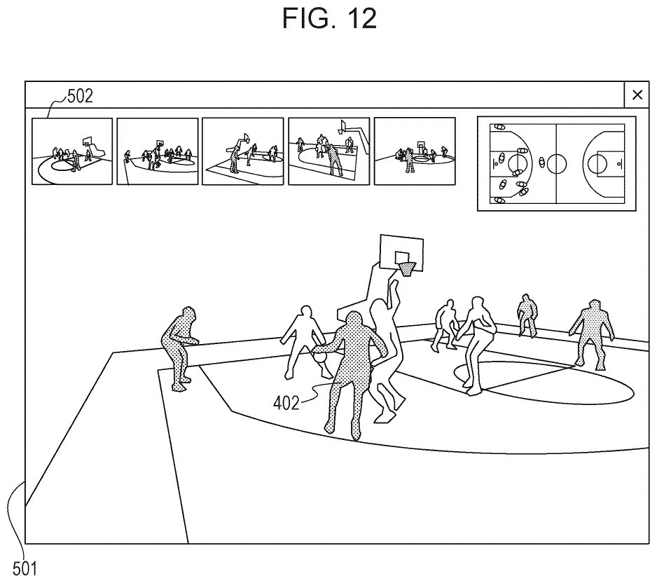

FIG. 12 is an explanatory diagram for describing display viewpoints to be displayed on the display unit 109 and determination processing of a display order. When subjects of two people are captured and pursued as image capturing targets, since the number of virtual viewpoints is low, even when two virtual viewpoint images for switching are displayed in the display regions 502 of the virtual viewpoint for switching, the user can easily find a desired virtual viewpoint image for switching. On the other hand, when a competition or the like which is held with a large number of people, such as basketball or baseball, is set as an image capturing target, there is a possibility that it is not easy for the user to identify a desired virtual viewpoint since the virtual viewpoints are set in accordance with the number of players. For this reason, according to the present embodiment, an example will be described in which three or more virtual viewpoint images from among six or more generated virtual viewpoint image are displayed as the virtual viewpoint images for switching. It is noted that the number of images to be displayed as the virtual viewpoint images for switching is not limited to five, and may be changed depending on a size of a display apparatus, a size of the virtual viewpoint image for switching, or the like. First, the virtual viewpoint image for switching among the plurality of virtual viewpoint images is decided based on a distance between the three-dimensional model of the subject which is set as the pursuit target in the virtual viewpoint image for operation and the three-dimensional model of the subject which is set as the pursuit target in the virtual viewpoint image for switching. In the above-described case, the display viewpoint control unit 901 computes a distance between the three-dimensional model of the subject set as the pursuit target in the virtual viewpoint image for operation and the three-dimensional model of the subject set as the pursuit target in the virtual viewpoint image for switching. Then, it is determined that a previously set number of virtual viewpoint images in ascending order of the distance are displayed as the virtual viewpoints for switching. A method of deciding the virtual viewpoint images for switching to be displayed is not limited to this. It may be determined that a pursuit viewpoint targeting a three-dimensional model of a player in the same team (with the same attribute) as the three-dimensional model of the subject set as the pursuit target at the virtual viewpoint for operation is displayed. In this case, the display viewpoint control unit 901 refers to the attribute information included in the identifier of each of the tracked three-dimensional models acquired from the accumulation unit 104. Then, it is determined that the pursuit viewpoint pursuing the three-dimensional model having the attribute which matches the three-dimensional model of the pursuit target at the virtual viewpoint for operation is displayed. In the example of FIG. 12, players in the same team as the three-dimensional model which is set as the pursuit target in the display region 501 of the virtual viewpoint for operation are displayed while being hatched in the display regions 502 of the virtual viewpoint for switching. It is noted that a method of displaying the subject having the same attribute information is not limited to this. For example, an outline of the three-dimensional model of the subject may be highlighted, and the subject which does not have the same attribute information may be set to be semi-transparent. It is noted that according to the present embodiment, which of the virtual viewpoint images to be displayed as the virtual viewpoint image for operation is identified by a user operation.

Next, the determination on the arrangement order for displaying the virtual viewpoint images for switching is decided, for example, based on a distance between the three-dimensional model of the pursuit target at each of the pursuit viewpoints and the object-of-interest. In the above-described case, the display viewpoint control unit 901 computes a distance between each of the three-dimensional models and the object-of-interest from the acquired position information of each of the three-dimensional models and decides the arrangement order in ascending order of the value of the distance. In the example of FIG. 12, the virtual viewpoint images for switching are displayed in the display regions 502 of the virtual viewpoint for switching from the left in ascending order of the value of the distance. The arrangement order of the virtual viewpoint images for switching may be decided in accordance with information acquired from the outside of the image generation apparatus 10. For example, a field goal success rate of each player may be acquired to arrange the virtual viewpoint images for switching corresponding to players in descending order of the success rate. Alternatively, position information of each player may be acquired to arrange the virtual viewpoint images for switching corresponding to the players depending on the field goal success rate in an area where the player stands.

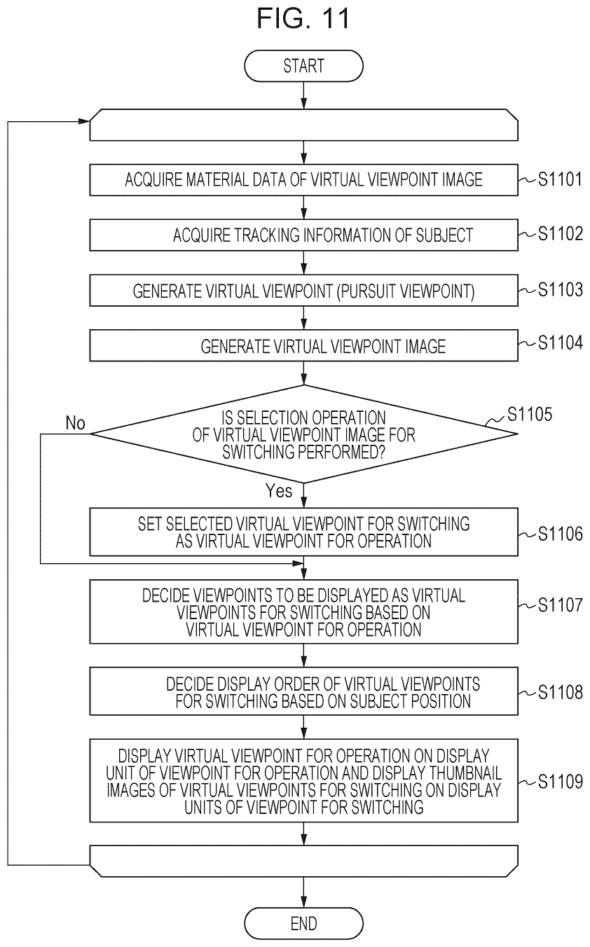

FIG. 11 is a flowchart illustrating processing for the image generation apparatus 10 to display the virtual viewpoint image for operation and the virtual viewpoint images for switching on the display unit 109. The present processing is executed for an update interval of the virtual viewpoint image for operation. According to the present embodiment, it is assumed that the virtual viewpoint images displayed as the virtual viewpoint image for operation and the virtual viewpoint images for switching are video images at 60 frames per second. For this reason, the present processing (S1101 to S1109) is executed in every frame. It is noted that the configuration is not limited to this, and the present processing may be executed in every multiple frames. Alternatively, update intervals may be varied for the virtual viewpoint image for operation and the virtual viewpoint images for switching. In addition, it is assumed that an initial value (virtual viewpoint) of the virtual viewpoint for operation is set in advance.

In step S1101, the three-dimensional model generation unit 102 acquires the material data of the virtual viewpoint images. Specifically, the three-dimensional model generation unit 102 generates the three-dimensional model of the subject based the plurality of images and the parameters of the positions and the orientations of the respective image capturing apparatuses which are received from the image capturing system 101. It is noted that the configuration is not limited to this, and the three-dimensional model of the subject may be acquired from another apparatus. In the above-described case, the position information of the three-dimensional models and the identifiers including the attribute information are also acquired, and step S1102 is skipped.

In step S1102, the three-dimensional model tracking unit 103 acquires the tracking information of each subject. The three-dimensional model tracking unit 103 tracks the position information of each of the three-dimensional models generated by the three-dimensional model generation unit 102. Then, the three-dimensional model tracking unit 103 appends the identifier to each of the three-dimensional models to be transmitted to the accumulation unit 104 together with the position information (tracking information).

In step S1103, the virtual viewpoint generation unit 105 generates the virtual viewpoint (pursuit viewpoint). Specifically, the plurality of virtual viewpoint generation units 105 generate, for the respectively designated subjects, the camera parameters serving as the pursuit viewpoints based on the position information of the three-dimensional models which is received from the accumulation unit 104. According to the present embodiment, such a camera parameter is generated that the pursuit target and the object-of-interest are included in the viewing angle of the virtual camera. As a result, the virtual viewpoint images at all the pursuit viewpoints include the mutually different subjects and also include the same object-of-interest.

In step S1104, the virtual viewpoint image generation unit 106 acquires the material data from the accumulation unit 104 and acquires the camera parameters from the virtual viewpoint generation units 105. Then, the virtual viewpoint image generation unit 106 performs rendering of the three-dimensional model of the subject viewed from the position and the orientation of the virtual camera to generate the virtual viewpoint image. It is noted that since one set of the virtual viewpoint generation unit 105 and the virtual viewpoint image generation unit 106 is provided for each pursuit target, virtual viewpoint images, the number of which is equivalent to the number of the pursuit targets, are generated.

In step S1105, the display viewpoint control unit 901 determines whether or not an operation of selecting any of the virtual viewpoint images for switching which are displayed in the display regions 502 of the virtual viewpoint for switching is performed by the user via the input unit 107. When the operation of selecting any of the virtual viewpoint images for switching is acquired, the flow proceeds to step S1106. When the operation is not acquired, the flow proceeds to step S1107.

In step S1106, the display switching unit 903 sets the virtual viewpoint of the virtual viewpoint image for switching which is selected in step S1105 as the virtual viewpoint for operation.

In step S1107, the display viewpoint control unit 901 determines the pursuit viewpoint to be displayed in the display region 502 of the virtual viewpoint for switching based on a relationship between the three-dimensional model of the subject set as the pursuit target at the virtual viewpoint for operation and the three-dimensional model of the subject set as the pursuit target at another virtual viewpoint.

A predetermined number of pursuit viewpoints among all of the pursuit viewpoints are set as the virtual viewpoints for switching based on a determination result.

In step S1108, the display order control unit 902 decides the arrangement order for displaying the pursuit viewpoints set in step S1107 as the virtual viewpoints for switching in the display regions 502 of the virtual viewpoint for switching based on the position information of the three-dimensional models of the subjects set as the respective pursuit targets.

In step S1109, the display switching unit 903 disposes the virtual viewpoint image at the pursuit viewpoint set as the virtual viewpoint for operation in the display region 501 of the virtual viewpoint for operation. The virtual viewpoint images at the pursuit viewpoints set as the virtual viewpoints for switching are arranged in the display regions 502 of the virtual viewpoint for switching.

By repeating the above-described processing in each frame, the virtual viewpoint images for switching and the virtual viewpoint image for operation include the mutually different subjects and the same object-of-interest. As a result, it is facilitated for the user to figure out the relationship between the virtual viewpoint for operation and the virtual viewpoints for switching in terms of the position and the orientation.

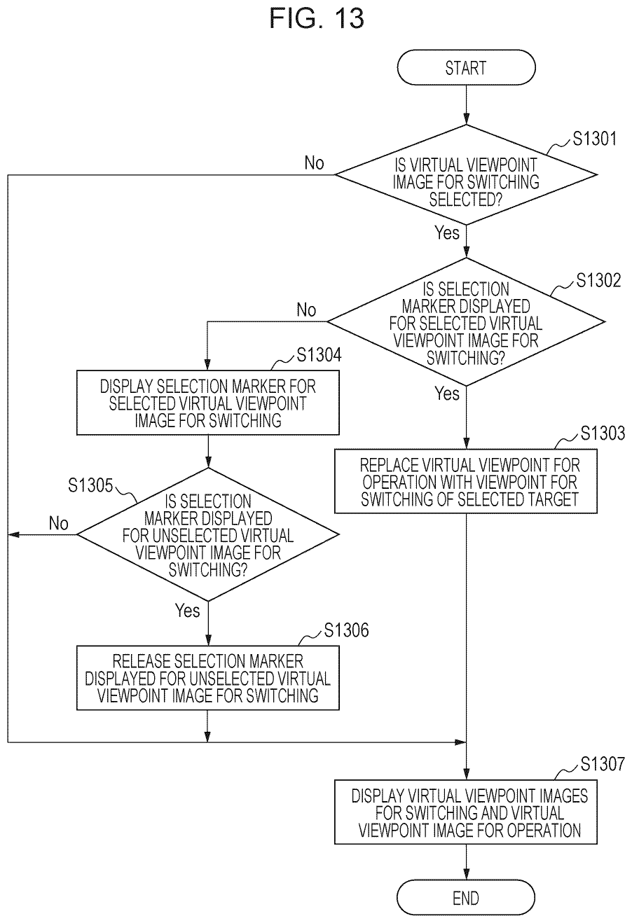

FIG. 13 is a flowchart representing a flow of processing of switching the selected virtual viewpoint for switching as the virtual viewpoint for operation. The present processing is also executed for the update interval of the virtual viewpoint image for operation similarly as in the processing illustrated in FIG. 11, and according to the present embodiment, the processing is executed in each frame.

In step S1301, the display switching unit 903 determines whether or not an operation for the user to select any of the virtual viewpoint images for switching via the input unit 107 is acquired. When the selection operation is acquired, the flow proceeds to step S1302. When the selection operation is not acquired, the flow proceeds to step S1307.

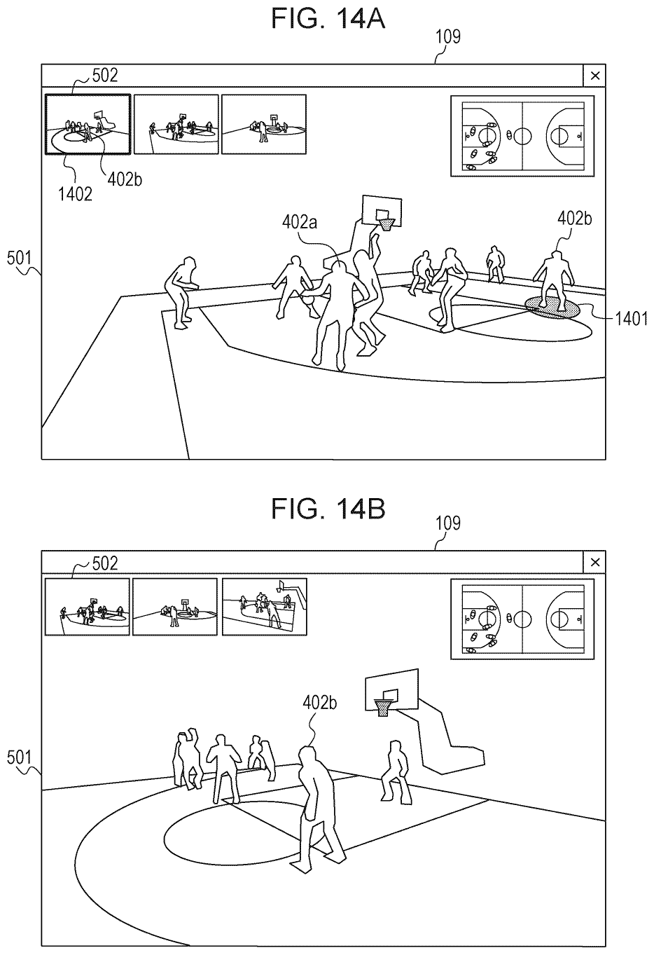

In step S1302, the marker control unit 904 determines whether or not a selection marker is displayed for the selected virtual viewpoint image for switching. When the selection marker is displayed, the flow proceeds to step S1303. When the selection marker is not displayed, the flow proceeds to step S1304. The selection marker is a circular icon as denoted by reference sign 1401 in FIG. 14A.

In step S1303, the display switching unit 903 sets the virtual viewpoint corresponding to the selected virtual viewpoint image for switching as the virtual viewpoint for operation. Furthermore, the display switching unit 903 releases the selection marker displayed for the three-dimensional model of the subject set as the pursuit target in the selected virtual viewpoint image for switching and a thick frame displayed for the selected virtual viewpoint image for switching.

In step S1304, for the virtual viewpoint image displayed in the display region 501 of the virtual viewpoint for operation, the marker control unit 904 superimposes the selection marker on the position of the three-dimensional model of the subject set as the pursuit target in the virtual viewpoint image for switching which is selected by the user. Furthermore, the marker control unit 904 displays a thick frame 1402 for the selected virtual viewpoint image for switching which is displayed in the display region 502 of the virtual viewpoint for switching.

In step S1305, the marker control unit 904 determines whether or not the selection marker is displayed for the three-dimensional model of the subject set as the pursuit target of the virtual viewpoint image for switching which is different from the virtual viewpoint image for switching which is selected by the user and acquired in step S1301. When the selection marker is displayed, the flow proceeds to step S1306, and when the selection marker is not displayed, the flow proceeds to step S1307.

In step S1306, the marker control unit 904 releases (deletes) the selection marker displayed for the three-dimensional model of the subject set as the pursuit target of the virtual viewpoint image for switching which is different from the virtual viewpoint image for switching which is selected by the user. Furthermore, when the thick frame 1402 is displayed for the virtual viewpoint image for switching which is different from the virtual viewpoint image for switching which is selected by the user, the marker control unit 904 releases (deletes) the thick frame.

In step S1307, the display switching unit 903 displays the virtual viewpoint images for switching and the virtual viewpoint image for operation on the display unit 109.

The user can easily figure out the subject which is set as the pursuit target of the virtual viewpoint image for switching through the above-described processing. In particular, when a large number of subjects set as the pursuit targets are present, since the number of virtual viewpoint images for switching also increases, there is a possibility that it is not easy to figure out the virtual viewpoint image for switching desired by the user. In the above-described case, by performing the above-described processing, it becomes possible to easily figure out which of the virtual viewpoint images for switching corresponds to each of the subjects in the virtual viewpoint image for operation. It is noted that according to the present embodiment, the selection marker is displayed, but the configuration is not limited to this. A color of a three-dimensional model of the subject set as the target may be changed, or an outline may be highlighted for the display. In addition, as a modification example, since the user selects the subject on the virtual viewpoint image for operation, the corresponding virtual viewpoint image for switching may be highlighted, or both the subject on the virtual viewpoint image for operation and the virtual viewpoint image for switching may be highlighted. In the case of this modification example, since it is possible to intuitively figure out the position of the corresponding subject of the virtual viewpoint image for switching, the position and the orientation of the virtual camera of the virtual viewpoint image for switching can be more easily figured out.

FIG. 14A and FIG. 14B illustrate display screens to be displayed in processing of switching the selected virtual viewpoint image for switching and the virtual viewpoint image for operation.

In an example of FIG. 14A, the leftmost virtual viewpoint image for switching among the virtual viewpoint images for switching which are displayed in the display regions 502 of the virtual viewpoint for switching is selected by the user, and surrounded by the thick frame indicating a selected state. When any of the virtual viewpoint images for switching is put into the selected state, in the virtual viewpoint image for operation which is displayed in the display region 501 of the virtual viewpoint for operation, the selection marker 1401 is superposed on the position of the three-dimensional model of the subject set as the pursuit target in the virtual viewpoint image for switching in the selected state. The selection marker 1401 is displayed in a position of feet (z=0 m) of the player 402b based on the tracked position information. Herein, a suffix “a” to the player 402 represents a pursuit viewpoint displayed in the display region 501 of the virtual viewpoint for operation, and a suffix “b” represents a player displayed in the display region 502 of the virtual viewpoint for switching in the selected state.

FIG. 14A illustrates a result of an operation for the user to switch the virtual viewpoint for switching in the selected state to the virtual viewpoint for operation via the input unit 107. The virtual viewpoint for switching which has been in the selected state in FIG. 14A is switched to the virtual viewpoint for operation to be displayed in the display region 501 of the virtual viewpoint for operation. When the virtual viewpoint for operation is switched, the pursuit viewpoint to be newly displayed in the display region of the virtual viewpoint for switching is set by the display viewpoint control unit 901 to be sorted in the arrangement order set by the display order control unit 902. Furthermore, the selection marker 1401 displayed in the virtual viewpoint image for operation and the thick frame displayed in the virtual viewpoint image for switching as displayed in FIG. 14A are released.

According to the present embodiment, the virtual viewpoint image for switching which can be switched at any timing is displayed as a candidate of the virtual viewpoint for operation at which the user performs the operation. Among a plurality of virtual viewpoint images, a plurality of virtual viewpoint images for switching are decided based on a relationship with the three-dimensional model pursued in the virtual viewpoint image for operation. Then, the display order of the virtual viewpoint images for switching is decided based on the position information of the three-dimensional model of the subject set as the pursuit target in each of the virtual viewpoint images. Since the virtual viewpoint image for operation and the virtual viewpoint images for switching described above are such pursuit viewpoints as to include the same object-of-interest, it is possible to easily figure out the position and the orientation of the switchable virtual camera.

It is noted that according to the present embodiment, when the virtual viewpoint image for switching which is displayed in the display region 502 of the virtual viewpoint for switching is selected, the corresponding virtual viewpoint is set as the virtual viewpoint for operation. In other words, the virtual viewpoint image for operation is replaced with the selected virtual viewpoint image for switching. On the other hand, the configuration is not limited to this, and the selected virtual viewpoint image for switching may be enlarged to the virtual viewpoint image for operation to be displayed.

In the above-described case, the virtual viewpoint image for switching which is enlarged to be displayed as the virtual viewpoint image for operation is highlighted. This modification example is advantageous when the number of pursuit viewpoints is low.

It is noted that according to the present embodiment, it is assumed that each of the virtual viewpoint images is an image viewed from the pursuit viewpoint for pursuing the particular subject. For this reason, in order that the subject corresponding to each of the virtual viewpoint images can be easily figured out, the corresponding subject may be displayed so as to be distinguishable from another subject in each of the virtual viewpoint images. For example, a color of the subject corresponding to the virtual viewpoint image may be changed, or a circular icon may be displayed in the position of the subject for highlighting. In the above-described case, highlighting different from the selection marker in FIG. 14A is to be performed.

According to the embodiments of the present disclosure, it is possible to easily figure out the position and the orientation of the switchable virtual camera.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-105952, filed Jun. 28, 2023, which is hereby incorporated by reference herein in its entirety.

What is claimed is:

1. An image processing apparatus comprising:
one or more memories storing instructions; and
one or more processors executing the instructions to:
acquire three or more virtual viewpoint images which include a same subject; and
perform control in a manner that a particular virtual viewpoint image among the three or more virtual viewpoint images displayed in first display regions is displayed in a second display region which is larger than the first display regions based on a user operation.

2. The image processing apparatus according to claim 1, wherein
the three or more virtual viewpoint images correspond to mutually different subjects which are subjects different from the same subject.

3. The image processing apparatus according to claim 2, wherein
the three or more virtual viewpoint images include respectively corresponding subjects and the same subject.

4. The image processing apparatus according to claim 2, wherein
the three or more virtual viewpoint images are displayed in a manner that respectively corresponding subjects and another subject are distinguishable respectably.

5. The image processing apparatus according to claim 1, wherein
the one or more processors further execute the instructions to acquire a user operation of selecting the particular virtual viewpoint image among the three or more virtual viewpoint images.

6. The image processing apparatus according to claim 1, wherein
the first display regions and the second display region are included in different display apparatuses.

7. The image processing apparatus according to claim 1, wherein
the first display regions and the second display region are included in a same display apparatus.

8. The image processing apparatus according to claim 1, wherein
when a first user operation is acquired, control is performed in a manner that a subject corresponding to the particular virtual viewpoint image displayed in the first display region and/or the particular virtual viewpoint image included in the virtual viewpoint image displayed in the second display region is highlighted, and when a second user operation is acquired, control is performed in a manner that the particular virtual viewpoint image is displayed in the second display region.

9. The image processing apparatus according to claim 8, wherein
the first user operation is an operation of selecting the particular virtual viewpoint image among the three or more virtual viewpoint images displayed in the first display regions or an operation of selecting the subject corresponding to the particular virtual viewpoint image included in the virtual viewpoint image displayed in the second display region.

10. The image processing apparatus according to claim 8, wherein
The second user operation is an operation of selecting the highlighted particular virtual viewpoint image displayed in the first display region and/or an operation of selecting the highlighted subject corresponding to the particular virtual viewpoint image included in the virtual viewpoint image displayed in the second display region.

11. The image processing apparatus according to claim 1, wherein
the same subject is a stationary object.

12. The image processing apparatus according to claim 11, wherein
the same subject is a goal.

13. An image processing method comprising:
acquiring three or more virtual viewpoint images which include a same subject; and
performing display control in a manner that a particular virtual viewpoint image among the three or more virtual viewpoint images displayed in first display regions is displayed in a second display region which is larger than the first display regions based on a user operation.

14. A non-transitory computer-readable storage medium storing a computer program for causing a computer to execute an image processing method comprising:
acquiring three or more virtual viewpoint images which include a same subject; and
performing display control in a manner that a particular virtual viewpoint image among the three or more virtual viewpoint images displayed in first display regions is displayed in a second display region which is larger than the first display regions based on a user operation.
